(19) United States
(12) Patent Application Publication
(10) Pub. No.: US 2014/0280315 A1
(43) Pub. Date: Sep. 18, 2014

(54) Athlete Recruiting Network

(71) Applicants: Ira C. Waddey, JR., Nashville, TN (US); James Robert Humphreys, JR., Nashville, TN (US)

(72) Inventors: Ira C. Waddey, JR., Nashville, TN (US); James Robert Humphreys, JR., Nashville, TN (US)

(21) Appl. No.: 14/210,483

(22) Filed: Mar. 14, 2014

Related U.S. Application Data
(60) Provisional application No. 61/788,076, filed on Mar. 15, 2013.

(51) Int. Cl. G06F 17/30

(52) U.S. Cl. CPC G06F 17/30289
USPC 707/769

(57) ABSTRACT

An athlete recruiting network in which athletes create athlete profiles that are stored within an athlete module of a recruiting database. One or more coaches use coach interfaces to create coaching rosters that are stored within a coach module within the recruiting database. The athlete interfaces and the coach interfaces include computers, laptops, telephones and other forms of remote terminals that are wired or wirelessly connected to the database. The athlete recruiting network allows coaches to search for one or more athletes based on desired characteristics such as athletic statistics, the athlete's position or particular skills, the athlete's academic achievements, and other criteria designated by the coach. Further, the athlete-recruiting network allows the athletes to promote their particular skills or abilities to coaches searching for athletes to complete the coach's roster.

### CROSS-REFERENCE TO RELATED APPLICATION

This application claims priority to U.S. Provisional Application Ser. No. 61/788,076 flied Mar. 15, 2013, and entitled Athlete Recruiting Network, incorporated by reference herein in its entirety.

### FIELD

This invention relates to the field of computer implemented athletic recruiting networks. Specifically, the present disclosure is related to a computer network for enhancing communication between athlete recruits and coaches.

### BACKGROUND

Every year thousands of high school athletes, such as basketball and football players, participate in the recruiting process to attempt to earn a position on a collegiate team. However, an extremely limited number of positions are available on collegiate teams relative to the number of high school athletes seeking to compete at the collegiate level. Further, it is often difficult for high school athletes to connect with coaches and recruiters of teams seeking athletes to fill needed positions on their teams.

Coaches and recruiters must sort through thousands of potential recruits based on their abilities. It is often difficult to sort a large number of potential recruits having desirable traits to fill needed positions within a team. It is also difficult for coaches to verify athlete statistics and to further learn of potentially unheralded athletes that possess suitable traits for a particular team.

What is needed, therefore, is an athlete-recruiting computer network and method for enhancing athlete recruiting and for enhancing communication between potential recruits and coaches and recruiters.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is an illustration of an athlete-recruiting network according to one embodiment of the disclosure;

FIGS. 2-4 are illustrations of an athlete profile;

FIGS. 5-9 illustrate a table containing an athlete's statistical performance;

FIGS. 10-12 illustrate a filtered search;

FIGS. 13-16 are illustrations of an athlete profile overview;

FIGS. 17-18 illustrate a coach's roster; and

FIGS. 19-20 illustrate adding a contributor.

### DETAILED DESCRIPTION

With initial reference to FIG. 1, the present disclosure relates to an athlete-recruiting network 10. One or more athletes use athlete interfaces 12 to create athlete profiles 14 that are stored within an athlete module 16 of a recruiting database 18. One or more coaches use coach interfaces 20 to create coaching rosters 22 that are stored within a coach module 24 within the recruiting database 18. The athlete interfaces 12 and the coach interfaces 20 include computers, laptops, telephones and other forms of remote terminals that are wired or wirelessly connected to the database 18. The athlete-recruiting network 10 allows coaches to search for one or more athletes based on desired characteristics such as athletic statistics, the athlete's position or particular skills, the athlete's academic achievements, and other criteria designated by the coach. Further, the athlete-recruiting network allows the athletes to promote their particular skills or abilities to coaches searching for athletes to complete the coach's roster. As discussed herein, an athlete refers to a person who is proficient in sports and other forms of exercise including, but not limited to, football, baseball, basketball, soccer, tennis, golf, track and field, field hockey, and other related sports. Further, while reference is made to recruiting high school athletes for collegiate athletic programs, it is also understood that the athlete-recruiting network may enhance the recruiting of athlete's at other relevant levels of competition, such as professional athletics.

The recruiting database 18 may include at least one processor and memory, the memory comprising one or more of random access memory (RAM) and a main storage medium including one or more hard drives. The memory may be included within the database or, alternatively, may be located remotely from the system such as a cloud storage system. The database may communicate with one or more networks such as a local area network (LAN), a wireless network, and the Internet, and may thereby communicate with other databases through the one or more networks. The recruiting database may be contained in a single physical location or, alternatively, may be comprised of multiple components in multiple physical locations.

### Athlete Profile

Referring to FIGS. 2 and 3, the athlete may register with the recruiting database and create a profile that displays information relevant to the athlete such as the athlete's name, hometown, sport and position, in addition to other relevant information such as athletic statistics, academic achievements, social information, and highlight videos.

The athlete may access and input information into the recruiting database through the athlete interface 14 such as a terminal in communication with the network, such as through the Internet. The terminal may be a personal computer, smart phone, tablet, or other device enabling the athlete to communicate with the recruiting database.

When the athlete registers with the recruiting database, the athlete populates the athlete's profile with the relevant information as shown in FIGS. 2 and 3. Further, as shown in FIG. 4, the athlete may upload videos and pictures to be displayed on the athlete's profile. Videos and other relevant media may be uploaded to capture the athlete's abilities or otherwise showcase the athlete's skills for a particular sport or position. For example, the athlete may upload a video demonstrating the athlete completing a 40-yard dash in a time claimed by the athlete in the athlete's profile, or may demonstrate an athlete performing a particular workout to demonstrate the strength of the athlete. The athlete enters information relevant to the video to be uploaded including a video title, the type of video, the date the video was created, and any identifying criteria such as the athlete's jersey number. Each video may be categorized based on the content of the video, such as whether the video demonstrates the athlete performing various drills or the athlete's game or workout performances. After selecting the video and entering designated identifying criteria for the video, the video is uploaded from the athlete's terminal and transmitted to and stored on the recruiting database.

The athlete profile may further include detailed statistics of an athlete's individual performances during competition or in training Referring to FIG. 5, the athlete may input various statistics related to the athlete's performance as well as descriptions of that particular performance. The athlete designates a particular position that the athlete played during the performance such as quarterback, running back, or other positions of other relevant sports (FIG. 6).

FIG. 7 is an exemplary table of statistics populated by the athlete when the athlete is a football player, particularly a running back. In this example, statistics displayed include the number of rushing attempts, rushing yards, yards per carry, rushing touchdowns, and other relevant statistics regarding the athlete's performance at the running back position. The table may display the relevant statistics for each game an athlete competed in during a given season. The statistics entered by the athlete may further be compiled into season totals, such as the number of rushing yards an athlete obtained during a given season. Further, an athlete may enter multiple statistics for multiple positions in which the athlete performed during a given season. For example, if the athlete competed in a game at an additional position such as in the safety position, an additional table of statistics may be available to display the athlete's performance at the additional position such as tackles, interceptions, and other relevant defensive statistics.

Referring to FIG. 8, when an athlete desires to enter performance data corresponding to a recent athletic performance, the athlete may input information into the recruiting database such as the name of the opponent, the location of the event, the date of the event, and individual performance numbers for the particular event.

The recruiting database also enables an athlete to track their particular statistics over time and to further graphically plot the athlete's statistics to spot trends in the athlete's performance. For example, the athlete may plot the athlete's number of rushing yards per game or yards per carry over a given season to show improvement in the athlete's ability as a running back or to otherwise show the athlete's consistency over a given period of time.

Additional individual achievements or accomplishments may be entered for a particular athlete as part of the athlete's profile. For example, an athlete may enter other non-statistical athletic achievements for a given season, such as indicating that the athlete was a captain of a particular athletic team or indicating that the athlete made an all-state team. (FIG. 9).

When the athlete desires to input or otherwise update their statistics, the athlete may access their profile within the athlete module of the recruiting database through the terminal. In one embodiment, the athlete accesses their profile within the recruiting database using a personal computer and the Internet, and interfaces with the recruiting database through a web page. In another embodiment, the athlete may access their profile using a smart phone and a local application installed on the smart phone wherein the athlete updates their statistics using the local application and the updated statistics are then transmitted to the recruiting database. Further, video and other media information captured on the smart phone may be transmitted directly to the recruiting database through the local application.

As the athlete enters performance and academic information over multiple seasons, the athlete builds a performance history that may be observed over time as the athlete progresses. The athlete's performance is supported by various videos uploaded by the athlete and by information supplied by one or more contributors as disclosed below. By building a performance history with various media and contributors also supporting the athlete's performance history, the athlete-recruiting network enables coaches to evaluate the athlete's performance to determine whether the athlete has entered fraudulent performance data that does not represent the athlete's actual abilities. For example, if an athlete posts multiple data entries indicating that their 40-yard dash time is substantially greater than five seconds and posts one or more videos showing the athlete perform the 40-yard dash in over five seconds, and subsequently the athlete indicates that their 40-yard dash time is substantially lower without posting supporting media, this performance data may be viewed as an anomaly and flagged for further review by the coach.

### Coaching Roster

Coaches and recruiters may create a roster for locating athletes with profiles in the recruiting database and for building the roster based on the particular needs of the coach's team. The coach is able to filter various athletes based on desired traits or talents and further filter the athletes using academic and other criteria to identify athletes desired by the coach. The coach may then save a list of desired athletes for further contact for recruiting by the coach.

Referring to FIG. 10, the coach may search through various athlete profiles based on criteria such as the athlete's class, physical traits, or performance statistics. The coach may enter multiple filter criteria for sorting through athlete profiles to return athlete profiles matching the desired filter criteria inputted by the coach. FIG. 11 is an exemplary filter input showing desired filter criteria of an athlete running a 40 yard dash in under 5.5 seconds and an ACT score of greater than 29. As the coach enters filter criteria the number of athlete profiles that match the entered filter criteria is displayed to enable the coach to add or reduce the number of filter criteria to achieve a desired number of athlete profiles to display for further review.

After the coach enters the desired filter criteria for athlete profiles, the recruiting database displays any athlete profiles that match the entered filter criteria. As shown in FIG. 12, a snapshot of athlete profiles that match the filter criteria is shown displaying initial information about the athlete such as the athlete's name, recruit year, sport, positions, and date of birth. The snapshot view of athlete profiles allows a coach to quickly review information about athletes matching the filter criteria. Multiple snapshots of multiple athletes may be displayed when more than one athlete matches the filter criteria, and the returned athlete snapshots may be sorted based on the filter and other criteria. Further, the coach may customize the fields displayed in the snapshot, such as displaying the athlete's 40 yard dash time or other criteria.

When a coach desires to learn more about a particular athlete after reviewing the athlete's snapshot, the coach may select the desired athlete to review the particular athlete in detail. As shown in FIGS. 13 and 14, an athlete big picture view of the athlete's profile is shown as viewed by a coach on the recruiting database. The big picture view includes the information available on the snapshot view of the athlete's profile and additional information such as physical characteristics of the athlete, the athlete's performance statistics, academic honors, and various other information related to the particular athlete. The big picture view may further include a highlight video prepared and uploaded to the recruiting database by the athlete showing a compilation of notable footage for the particular athlete.

The coach may further view the videos uploaded by the athlete demonstrating the athlete's abilities or skills. FIG. 15 is an exemplary display of multiple athlete videos as viewed by a coach on the recruiting database. Each video is accompanied by a title and optionally a brief description of the video such as a description of the particular skill the athlete is demonstrating in the video, as well as any relevant statistics accompanying the video such as amount of weight lifted or time required to complete the particular workout demonstrated in the video.

The coach may build a roster of desired athletes based on athletes located during the filtered search. Referring to FIG. 16, when a coach views an athlete profile in the recruiting database, one or more options are available for the coach to save the athlete profile. The coach may elect to keep the athlete profile, draft the athlete onto the coach's draft board as described below, share the athlete profile with other coaches or assistant coaches, make notes on the particular athlete, contact the athlete, or cut the athlete from the coach's search.

The coach module includes a draft board for building a roster of athlete profiles located during the coach's filtered search. When a coach selects the draft option available for each athlete profile, the athlete profile is added to the coach's roster as illustrated in FIG. 17. The one or more athlete profiles added to the roster may be assigned a primary and secondary position, such as a primary position of running back and a secondary position of wide receiver. Referring to FIG. 18, the coach may then move each athlete profile to a designated category in the coach's roster. The coach may continue to add athlete profiles to the draft board to assemble a roster of desired athletes for contacting for recruiting purposes.

### Contributors

An athlete having an account in the recruiting database may invite one or more contributors to create an account in the recruiting database. Contributors may include family members, mentors, and friends of the athlete. FIG. 19 shows an invitation being created to send to an athlete contributor. Information such as the contributor's name, email address, and type of user is entered. For example, in the invitation to the contributor the contributor may be designated as an athlete, coach, mentor, or other supporter of the athlete.

When the athlete has completed entering information for the contributor, an invitation is sent to the contributor to join the athlete-recruiting network. In one example, the invitation may be automatically generated and sent by the recruiting database via email to the contributor. Alternatively, the athlete may send a link to the contributor for creating a profile in the recruiting database.

After the contributor has created an account, the contributor may submit additional information to be added to the athlete profile. Various information may be submitted to the athlete profile by the contributor such as additional video highlights of the athlete's abilities, statistics, or other information related to the particular athlete. The additional information is uploaded to the recruiting database and tagged such that the information corresponds to the particular athlete with whom the contributor is associated. When new information is uploaded, the athlete receives a notification from the recruiting database regarding the additional information, and the athlete may designate whether the athlete desires to keep the added information, remove the additional information, or edit the additional information.

A coach having an account in the recruiting database may invite one or more coaching contributors to create an account in the recruiting database. Coaching contributors may include other members of a coaching staff such as assistant coaches and position coaches. FIG. 20 shows an invitation being created to send to a coaching contributor. Information such as the contributor's name, email address, and type of user is entered. For example, in the invitation to the contributor the contributor may be designated as an offense assistant coach, defense assistant coach, or other relevant coaching position.

When the coach has completed entering information for the coaching contributor, an invitation is sent to the coaching contributor to join the athlete-recruiting network. In one example, the invitation may be automatically generated and send by email to the coaching contributor. Alternatively, the coach may send a link to the coaching contributor for creating a profile in the recruiting database.

After the coaching contributor has created an account, the contributor may submit additional information to contribute to the coach's search for athlete profiles. For example, if an assistant coach visits a high school and locates a talented little-known athlete, the assistant coach may login to the recruiting database, research the little-known athlete's profile, and transmit the athlete's profile to the coach along with notes describing the athlete's performance.

Referring again to FIG. 1, the athlete-recruiting network 10 facilitates the recruiting of athletes 12 by coaches 20 by allowing coaches and athletes to exchange information through the recruiting database 18. Coaches and athletes log in to the recruiting database through terminals in communication with the recruiting database. Athletes may populate their profiles with up to date information regarding their athletic and academic performance including videos and contributor information. The coaches may filter athlete profiles based on the athlete's performance data and build a roster comprising one or more athletes as disclosed above. Further, the coaches may communicate with one or more of the athletes through the recruiting database to express interest in recruiting the athlete and further following up with the athlete.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

What is claimed is:

1. An athlete-recruiting network for facilitating the recruiting of an athlete by a coach comprising:
one or more terminals in communication with a recruiting database, the recruiting database including
an athlete module comprising one or more athlete profiles, each athlete profile indicating one or more characteristics and preferences of the athlete, and
a coaching module for compiling a roster of one or more athlete profiles selected by the coach;
wherein the one or more athlete profiles are searchable based on one or more of the characteristics and preferences of the athlete.
